(19) United States
(12) Patent Application Publication
(10) Pub. No.: US 2022/0015344 A1
(43) Pub. Date: Jan. 20, 2022

(54) FISHING LURE

(71) Applicant: Jaboom Bait CO. LLC, Ama, LA (US)

(72) Inventor: Jeremy Norris, Ama, LA (US)

(21) Appl. No.: 17/443,048

(22) Filed: Jul. 20, 2021

Related U.S. Application Data
(60) Provisional application No. 63/053,822, filed on Jul. 20, 2020.

(51) Int. Cl. A01K 85/16

(52) U.S. Cl. CPC A01K 85/16

(57) ABSTRACT

A fishing lure includes a body, a plurality of ribs disposed on the outer surface of the body that envelope the body and cover between about 50% and about 100% of the outer surface of the body; and one or more appendages attached to the body. The ribs may cover between about 75% and 95% of the surface area of the body. The ribs may range between about 0.01 and about 0.5 inches wide. The ribs may extend from about 0.01 inches to about 0.5 inches outward from the surface of the body. The ribs may be spaced between about 0.01 inches and 0.1 inches apart. The body may be circular, oval, spheroidal, elliptical, or cylindrical in shape.

### CROSS REFERENCE TO RELATED APPLICATIONS

This application claims priority to U.S. provisional application No. 63/053,822 filed on Jul. 20, 2020, which is herein incorporated by reference in its entirety.

### BACKGROUND OF THE DISCLOSURE

### Field of the Invention

This disclosure generally relates to artificial fishing lures and fishing baits.

### Description of the Related Art

When fishing on waters that have mats of lilies, grass, or other surface plant growth, a fishing technique that is frequently used may be referred to as ‘punching’. ‘Punching’ generally refers to making casts, or otherwise flipping a bait or lure onto the surface of lilies or other plant growth with a weight attached allowing the bait or lure to ‘punch’ through the plant growth.

For example, in tournament bass angling, this is a technique that is frequently used. In bass angling, this technique may consist of making short casts (flipping) into the mats of lilies or grass, slop etc., with a heavy weight to punch the bait or lure through the mat. In this way, the bait or lure can be presented to the fish hiding under the plant growth. Current state-of-the-art soft plastic baits are smooth surfaced or have ribs that are configured in a horizontal position on the bait.

A problem with the smooth surface on conventional baits is that they become sticky after a short time and begin gleaning or sticking to lilies and other objects or plant growth. A problem with horizontal configured ribbed baits is that the horizontal ribs catch, grab, and hang onto objects or plant growth in the mat.

Accordingly, there is a need in the art for better baits for fishing in waters that have mats of lilies, grass, or other surface plant growth.

### SUMMARY OF THE INVENTION

In embodiments, a fishing lure includes a body, a plurality of ribs disposed vertically on the outer surface of the body that surround the body and cover between about 50% and about 100% of the outer surface of the body; and one or more appendages attached to the body. The ribs may cover between about 75% and 95% of the surface area of the body. The ribs may range between about 0.01 and about 0.5 inches wide. The ribs may extend from about 0.01 inches to about 0.5 inches outward from the surface of the body. The ribs may be spaced between about 0.01 inches and about 0.1 inches apart. The body may be circular, oval, spheroidal, elliptical, or cylindrical in shape.

Other features and aspects will be apparent from the following detailed description, the drawings, and the claims.

### BRIEF DESCRIPTION OF THE DRAWINGS

FIG. 1 shows an example of a fishing lure of the disclosure.

FIG. 2 shows another embodiment of a fishing lure of the disclosure.

FIG. 3 shows another embodiment of a fishing lure of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

The present disclosure provides a bait that has ribs that are configured vertically on the bait. This allows the bait to make a much smoother penetration through a mat. The vertical ribs provide a more streamlined bait or lure and have less surface area touching the mat. This provides a bait that can consistently move through the mat or plant growth and provides a smoother and more consistent presentation. In addition, an optional feature of the bait can also include legs that have a double action.

Accordingly, in embodiments, a fishing lure of the disclosure includes a body and one or more appendages attached to the body. The body generally includes outer ribs disposed lengthwise or vertically running along the body. In preferred embodiments, the body of the lure can be circular, oval, spheroidal, or cylindrical in shape. In preferred embodiments, the body is generally spheroidal or cylindrical in shape, and the ribs extend between about 50% to about 100% of the length of the body. In preferred embodiments, the ribs may extend from about 75% to about 95% of the length of the body.

The ribs are generally disposed on an outer surface of the body of the lure and encircle, surround, or envelope the body. In preferred embodiments, the ribs completely encircle or envelope the body over about 50% to about 100% of the outer surface of the body.

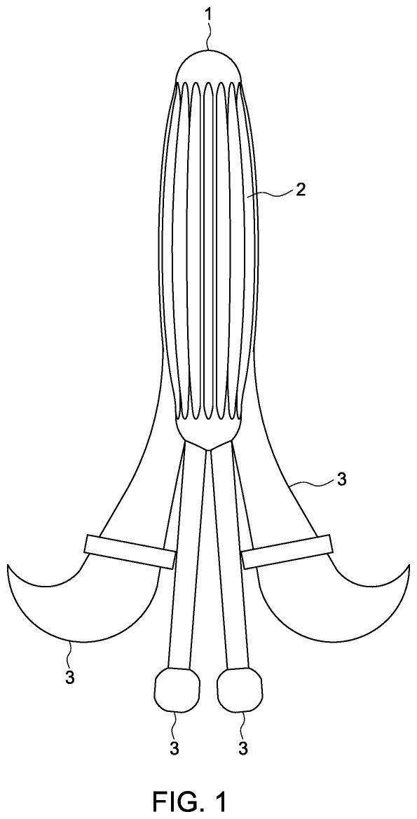

FIG. 1 shows one example of a fishing lure of the disclosure. FIG. 1 shows body 1, ribs 2, and appendages 3. As shown in FIG. 1, a series of vertical ribs 1 are disposed laterally on the body of the lure. In addition, appendages 3 are shown which are provided with a double action feature. As shown in FIG. 1, the ribs may extend vertically substantially from one end of the body of the lure to the other. In this example, the ribs extend over about 80% to 85% of the length of the body.

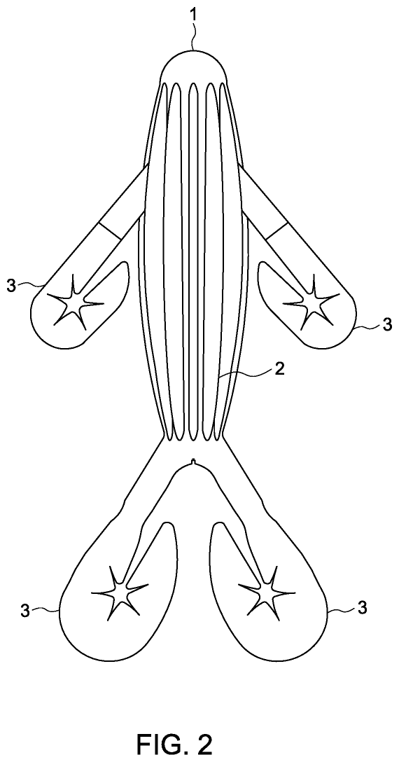

FIG. 2 shows another embodiment of a fishing lure of the disclosure. FIG. 2 also shows body 1, ribs 2, and appendages 3. Colors could include cantaloupe, black, blue, watermelon, green, red, blue, pumpkin, and combinations thereof, or other colors commonly used for fishing baits. In embodiments, the bait can be made from a soft plastic bait material including rubbery materials commonly used for soft baits and soft bait materials including polyvinyl alcohol and polyvinyl chloride. See Soft plastic bait, Wikipedia, the free encyclopedia, date of last revision: 28 May 2021, herein incorporated by reference.

In one specific embodiment of the fishing bait shown in FIG. 2, the body is approximately 2.29 inches long and the total length is approximately 3.4 inches. The thickness of the bottom appendages is approximately 0.09 inches and the lateral total width of each appendage at its widest part is approximately 0.55 inches. The length of the bottom section of each bottom appendage is approximately 0.83 inches long and the bottom section of each bottom appendage starts approximately 0.38 inches below the body. The lateral width of the side appendages at its widest part is approximately 0.38 inches and the thickness is approximately 0.05 inches. The side appendages start approximately 0.66 inches below the top of the body. The lateral width of the upper part or arm of each side appendage is approximately 0.16 inches. The total length of each side appendage is approximately 1.04 inches. The ribs are approximately 0.05 inches wide and spaced approximately 0.38 inches apart.

A bait as shown in FIG. 2 may more generally be about 3-6 inches long and may be made in a wide variety of colors. It may be used as a flipping bait, in a Carolina rig, a jig trailer or Texas rigged as examples. See e.g., Carolina rig, Wikipedia, the free encyclopedia, date of last revision: 11 Mar. 2021 herein incorporated by reference; and Texas rig, Wikipedia, the free encyclopedia, date of last revision: 31 Jan. 2021 herein incorporated by reference. Colors could include cantaloupe, black, blue, watermelon, green, red, blue, pumpkin, and combinations thereof, or other colors commonly used for fishing baits.

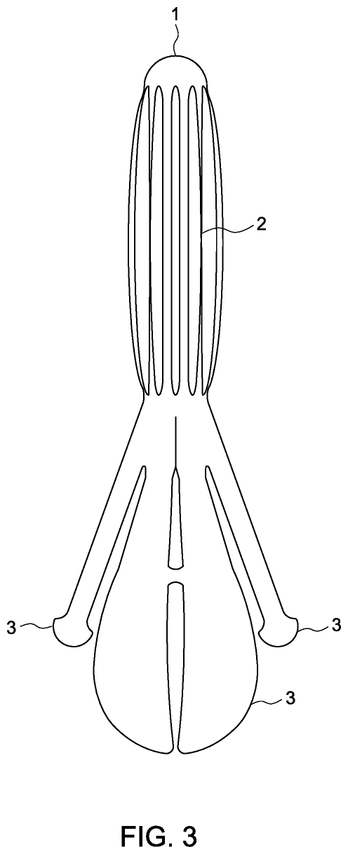

FIG. 3 shows another embodiment of a fishing lure/bait of the disclosure. FIG. 3 shows body 1, vertical ribs 2, and appendages 3. In embodiments, this bait is also made of a soft plastic bait material and may be about 4-7 inches long, preferably about 4.5 inches. This bait may also be made in a wide variety of colors and can be used as a flipping bait, in a Carolina rig, a jig trailer or Texas rigged as examples. Colors could include cantaloupe, black, blue, watermelon, green, red, blue, pumpkin, and combinations thereof, or other colors commonly used for fishing baits.

In one specific embodiment of a bait shown in FIG. 3, the body length is approximately 2.28 inches, and the total length is approximately 4.25 inches. The ribs are approximately 0.05 inches wide. The bottom central appendage is approximately 1.03 inches wide at its widest and approximately 1.73 inches long. The outer appendages are approximately 1.54 inches long and approximately 0.13 inches thick with the thickness of the tip being approximately 0.25 inches. The thickness of the bottom central appendage is also approximately 0.13 inches. The distance from the bottom of the body to the beginning of the bottom central appendage is approximately 0.24 inches. The distance from the top of the body, and the bottom of the body, to the respective beginning of the ribs is approximately 0.37 inches. The thickness of the connector of the central appendage is approximately 0.08 inches.

A body of a lure or bait as referred to herein, is generally an elongated, spherical, spheroidal, elliptical, and/or cylindrical structure made from rubber, plastic, metal, wood, composite, and/or other material commonly used for fishing lures. Preferably, the body is circular, oval, spheroidal, elliptical, or generally cylindrical in shape. A generally spheroidal, elliptical, or cylindrical body shape is preferred. As shown in the drawings, in preferred embodiments, the ribs extend vertically along a substantial portion of the cylindrically shaped body. Soft plastic bait materials are preferred.

A rib, as referred to herein, may be an elongated elevated structure running disposed vertically along the body of the lure. In embodiments, a rib may be from 0.01 in. to about 0.5 inches wide. In preferred embodiments, a rib may be from about 0.01 inches to about 0.1 inches wide and be about 0.05 inches wide. A rib may extend from about 0.01 inches to about 0.5 inches outward from the surface of the body of the lure. A rib may be made from soft bait material, plastic, metal, wood, composites, or any material commonly used for fishing lures. The ribs may be made from the same material as used for the body or different for a particular lure.

An appendage may range in length from about 0.1 inches to about 10 inches preferably about 1 inch to 6 inches and about 0.1 to about 3 inches wide or preferably about 0.25 to about 1.5 inches wide. Appendages may be made from soft bait material, plastic, metal, wood, composites, or any material commonly used for fishing lures. The appendages may be made from the same material as used for the body or different for a particular lure.

As discussed above, a plurality of ribs may be disposed closely spaced and surrounding or enveloping the body. In embodiments, the spacing between the ribs may range from about 0.01 to about 0.5 inches and preferably from about 0.05 to about 0.1 inches.

An appendage as referred to herein is an external part or elongated structure that protrudes from or is attached to the lure body. In embodiments, an appendage may generally resemble legs, fins, tails, or other appendages that occur on a frog, fish, insect, or small aquatic creature or organism. An appendage may be made from any of the materials used for the body and may be made from the same material as used for the body or different for a particular lure.

The disclosed fishing lure may also include one or more fishing hooks attached thereto, either to the body or one or more of the appendages.

### EXAMPLE

In one example, the disclosed lure is used in a punch rig that is used for bass fishing in heavy matted cover. This rig includes a heavy, approximately 8′ casting rod, 60-pound test line, a heavy-duty hook, for example, a flipping hook, 4/0 or 5/0 sized, and a quarter ounce to 3-ounce weight depending on the cover.

Generally, the rod will be a stiff action rod about 6′ to 8′ long, the weight will be between about ¼ ounce to about 4 ounces preferably about 1 ounce; the line will be between 40 to 70 lb test, and the hook will be a stiff flipping hook 3/0 to 6/0.

While this disclosure includes specific examples, it will be apparent after an understanding of the disclosure of this application has been attained that various changes in form and details may be made in these examples without departing from the spirit of the invention and its equivalents.

1. A fishing lure comprising:
a body;
a plurality of ribs disposed vertically on the outer surface of the body that surround the body and cover between about 50% and about 100% of the outer surface of the body; and
one or more appendages attached to the body.

2. The fishing lure of claim 1, wherein the ribs cover between about 75% and 95% of the surface area of the body.

3. The fishing lure of claim 1, wherein the ribs range between about 0.01 and about 0.5 inches wide.

4. The fishing lure of claim 1, wherein the ribs extend from about 0.01 inches to about 0.5 inches outward from the surface of the body.

5. The fishing lure of claim 1, wherein the ribs are spaced between about 0.01 inches and 0.1 inches apart.

6. The fishing lure of claim 1, wherein the body is circular, oval, spheroidal, elliptical, or cylindrical in shape.

7. A fishing lure comprising:
a body comprising a circular, oval, spheroidal, elliptical, or cylindrical shape;
a plurality of ribs disposed on the outer surface of the body that surround the body and cover between about 75% and about 95% of the outer surface of the body, wherein the ribs range from about 0.01 to about 0.1 inches wide, extend from about 0.01 inches to about 0.5 inches outward from the surface of the body, and are spaced between about 0.01 inches and 0.1 inches apart; and
one or more appendages attached to the body.

8. A Carolina fishing rig or a Texas fishing rig comprising the lure of claim 1.
